(19) United States
(12) Patent Application Publication
(10) Pub. No.: US 2010/0073594 A1
(43) Pub. Date: Mar. 25, 2010

(54) LIQUID CRYSTAL DISPLAY DEVICE

(75) Inventor: Hiroyuki Miyazaki, Mutsuzawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/564,239

(22) Filed: Sep. 22, 2009

(30) Foreign Application Priority Data
Sep. 22, 2008 (JP) 2008-243361

(51) Int. Cl. G02F 1/1333

(52) U.S. Cl. 349/58

(57) ABSTRACT

Provided is a liquid crystal display device, including: a liquid crystal substrate (LC) provided with a display region which displays an image by driving a liquid crystal material sandwiched between two substrates; an outer frame (OF) covering at least a part of an outside of the liquid crystal substrate (LC); an inner frame (IF) provided inside the outer frame (OF), for fixing the liquid crystal substrate (LC); and an adjusting screw (AS) arranged so as to couple the outer frame (OF) and the inner frame (IF) to each other, for adjusting a position of the display region with respect to the outer frame (OF) through adjusting a position of the inner frame (IF) with respect to the outer frame (OF).

### CROSS-REFERENCE TO RELATED APPLICATION

The present application claims priority from Japanese application JP 2008-243361 filed on Sep. 22, 2008, the content of which is hereby incorporated by reference into this application.

### BACKGROUND OF THE INVENTION

1. Field of the Invention

The present invention relates to a liquid crystal display device to be mounted to a casing forming a contour of a display such as a vehicle-mounted display.

2. Description of the Related Art

A vehicle-mounted display for displaying car navigation screen and the like is manufactured by mounting a module of a liquid crystal display device (hereinafter, simply referred to as liquid crystal display device) to a casing forming a contour of a display which is used by a user as a finished product. Generally, the liquid crystal display device includes a liquid crystal substrate for displaying images, videos, and the like in a predetermined display region, a fixing member for fixing the liquid crystal substrate, and a frame which covers the liquid crystal substrate and the fixing member from an outside thereof and is held by the casing (hereinafter, referred to as outer frame).

When the liquid crystal display device is mounted to the casing, the outer frame is positioned with respect to an opening of the casing for displaying the video and the like of the liquid crystal display device, to thereby be fixed to the casing.

### SUMMARY OF THE INVENTION

Generally, the liquid crystal display device has various dimension tolerances in members, such as a cutting tolerance of a glass substrate forming the liquid crystal substrate. It is difficult to further decrease each of the dimension tolerances such as the cutting tolerance. Due to influence of the dimension tolerances, a deviation occurs in a positional relation between the display region of the liquid crystal substrate and the outer frame. Further, the outer frame serves as a reference to be positioned with respect to the opening of the casing, and hence the deviation in the positional relation between the outer frame and the display region causes deviations which differ from display to display between the opening of the casing and the display region.

The present invention has been made in view of the above-mentioned problem, and an object of the present invention is therefore to provide a liquid crystal display device capable of adjusting the deviation in the display region with respect to the outer frame supported by the casing when the liquid crystal display device is mounted to the casing forming the contour of the display.

(1) In order to solve the above-mentioned problem, a liquid crystal display device according to the present invention includes: a liquid crystal substrate provided with a display region which displays an image by driving a liquid crystal material sandwiched between two substrates; an outer frame covering at least a part of an outside of the liquid crystal substrate; a fixing member provided inside the outer frame, for fixing the liquid crystal substrate; and an adjusting mechanism arranged so as to couple the outer frame and the fixing member to each other, for adjusting a position of the display region with respect to the outer frame through adjusting a position of the fixing member with respect to the outer frame. According to the liquid crystal display device of Item (1), it is possible to adjust a deviation in the display region with respect to the outer frame held by a casing of a display.

(2) In the liquid crystal display device of Item (1), the adjusting mechanism is subjected to adjusting operation by exposing at least a part thereof to an outside of the outer frame.

(3) In the liquid crystal display device of Item (2), the adjusting mechanism includes at least one adjusting screw which is inserted into a penetration hole formed in the outer frame and is screwed into a screw hole formed in the fixing member correspondingly to the penetration hole, and the at least one adjusting screw adjusts the position of the fixing member with respect to the outer frame through adjusting an interval provided between the outer frame and the fixing member by being subjected to rotation movement while exposing a screw head thereof to the outside of the outer frame.

(4) In the liquid crystal display device of Item (3), the fixing member includes an inner frame for supporting an outer peripheral portion of the liquid crystal substrate, and the at least one adjusting screw adjusts a position of the inner frame with respect to the outer frame through adjusting an interval between the outer frame and the inner frame.

(5) In the liquid crystal display device of Item (4), the inner frame has, on a portion supporting the outer peripheral portion of the liquid crystal substrate, at least one position fixing portion which is brought into contact with the liquid crystal substrate and determines a position of the liquid crystal substrate so as to fix the liquid crystal substrate.

(6) In the liquid crystal display device of Item (4) or (5), the inner frame has, on the portion supporting the outer peripheral portion of the liquid crystal substrate, a screw-hole-drilled wall having the screw hole formed therein, and the at least one adjusting screw adjusts the position of the inner frame with respect to the outer frame through adjusting an interval between the outer frame and the screw-hole-drilled wall by being screwed into the screw hole.

(7) In the liquid crystal display device of Item (5), the at least one position fixing portion is formed into a wall shape so as to be brought into contact with a region from a predetermined portion of at least one side of the liquid crystal substrate to an end portion of the liquid crystal substrate along the at least one side thereof and extend beyond the end portion of the liquid crystal substrate, the at least one position fixing portion has the screw hole formed therein in a portion extending beyond the end portion of the liquid crystal substrate, and the at least one adjusting screw adjusts the position of the inner frame with respect to the outer frame through adjusting an interval between the outer frame and the position fixing portion by being screwed into the screw hole.

(8) The liquid crystal display device of Item (4) or (5) further includes a light source section provided under the liquid crystal substrate, for supplying a light source to the liquid crystal substrate, in which the inner frame supports the outer peripheral portion of the liquid crystal substrate and covers sides of the light source section, the inner frame has the screw hole formed therein in a portion covering the sides of the light source section, and the at least one adjusting screw adjusts the position of the inner frame with respect to the outer frame through adjusting the interval between the outer frame and the inner frame by being screwed into the screw hole.

(9) In the liquid crystal display device of any one of Item (3) to (8), the adjusting mechanism includes other adjusting screws provided to a portion other than that on an extended line of the at least one adjusting screw, the other adjusting screws including: at least one of the other adjusting screws for adjustment in the same direction as a direction of the interval to be adjusted by the at least one adjusting screw; and at least another one of the other adjusting screws for adjustment in a direction perpendicular to the direction of the interval. According to the liquid crystal display device of Item (9), it is possible to adjust even a deviation in a rotating direction of the display region of the liquid crystal display device.

(10) In the liquid crystal display device of any one of Item (1) to (9), the outer frame and the fixing member are temporarily fixed to each other so as to form together a temporarily fixing portion for restricting a positional relation therebetween, and the adjusting mechanism adjusts the position of the fixing member with respect to the outer frame within a range in which the outer frame and the fixing member are restricted by the temporarily fixing portion.

(11) In the liquid crystal display device of any one of Item (2) to (10), the outer frame has, in a portion in which the part of the adjusting mechanism is exposed, a recess formed so as to receive the part of the adjusting mechanism.

(12) In the liquid crystal display device of any one of Item (4) to (8), the inner frame is integrally molded of a metal and a resin, and at least a portion of the inner frame is made of the resin, the portion thereof having the screw hole which is formed therein and into which the at least one adjusting screw is screwed.

### BRIEF DESCRIPTION OF THE DRAWINGS

In the accompanying drawings:

FIG. 1 is a developed perspective view illustrating main members of a liquid crystal display device according to a first embodiment of the present invention;

FIG. 2 is a perspective view of the liquid crystal display device according to the first embodiment of the present invention;

FIG. 3 is a view illustrating an example of a tolerance which is regulated in the liquid crystal substrate according to the first embodiment of the present invention;

FIG. 4 is a top view of a liquid crystal display device according to each embodiment of the present invention;

FIG. 5 is a sectional view taken along the line V-V of FIG. 4, which schematically illustrates a state of one of adjusting screws interposed between an inner frame and an outer frame in the first embodiment of the present invention;

FIG. 6 is a sectional view taken along the line VI-VI of FIG. 4, which schematically illustrates a state of one of adjusting screws interposed between an inner frame and an outer frame in a second embodiment of the present invention;

FIG. 7 is a sectional view taken along the line VI-VI of FIG. 4, which schematically illustrates a state of one of adjusting screws interposed between an inner frame and an outer frame in a third embodiment of the present invention; and

FIG. 8 is a view schematically illustrating a state in which adjusting screws are provided in an inner frame to which a liquid crystal substrate is fixed in a fourth embodiment of the present invention.

### DETAILED DESCRIPTION OF THE INVENTION

### First Embodiment

Hereinafter, embodiments of the present invention are described with reference to the drawings.

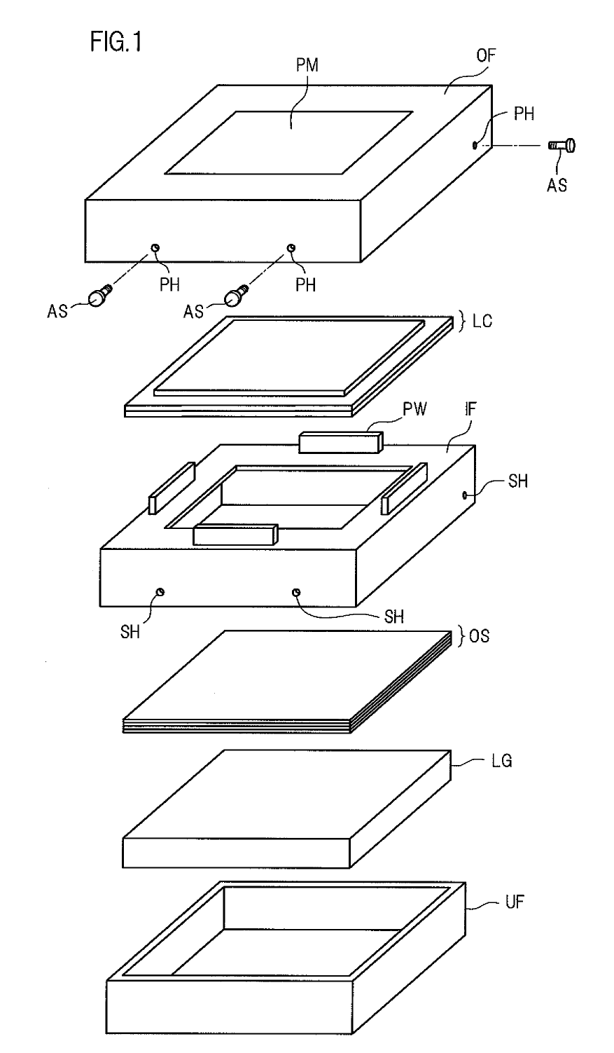

FIG. 1 is a developed perspective view illustrating main members of a liquid crystal display device according to a first embodiment of the present invention. As illustrated in FIG. 1, the liquid crystal display device according to the first embodiment of the present invention includes an outer frame OF, a liquid crystal substrate LC, an inner frame IF, an optical sheet OS, a light guide plate LG, and an under frame UF.

First, the liquid crystal substrate LC includes a TFT substrate which is a glass substrate on which thin film transistors (TFTs) are formed in a matrix, and a color filter substrate which is a glass substrate on which color filters are formed. The TFT substrate and the color filter substrate sandwich a liquid crystal material therebetween. Herein, the liquid crystal material means a material which has both fluidity of liquid and optical characteristics of solid (crystal), and can control a state of light by changing orientation of liquid crystal molecules constituting the liquid crystal material owing to a voltage or the like. Further, on the color filter substrate, there is formed an upper polarizing plate on a side opposite to a side on which the color filter substrate sandwiches the liquid crystal material. On the TFT substrate, there is formed a lower polarizing plate on a side opposite to a side on which the TFT substrate sandwiches the liquid crystal material. A driver and a flexible printed substrate are further provided on the liquid crystal substrate LC, and they send power and signals to each pixel circuit, to thereby drive the liquid crystal material.

Light is emitted to the liquid crystal substrate LC from the surface-emitting light guide plate LG via the optical sheet OS, and the emitted light becomes linearly polarized light when passing through the lower polarizing plate. Then, when passing through the liquid crystal material, the linearly polarized light is controlled in polarization direction in each pixel in accordance with a crystalline state of the liquid crystal material. In accordance with its polarization state, the linearly polarized light is transmitted through the upper polarizing plate, or blocked thereby. In the liquid crystal substrate LC, the liquid crystal material controls the polarization direction to selectively transmit the light through the upper polarizing plate. As a result, images or videos are formed.

Further, in the liquid crystal display device according to this embodiment, there is provided the under frame UF for receiving the light guide plate LG and the optical sheet OS. The light guide plate LG is formed by injection molding of, for example, a resin, and has a light-emitting surface which emits light toward a side on which the liquid crystal substrate LC is provided. Further, the optical sheet OS causes the light from the light-emitting surface of the light guide plate LG to enter the liquid crystal substrate LC such that substantially uniform luminance distribution is achieved. A light-emitting diode (LED) light source serving as a light-emitting element which generates light is provided, for example, at a predetermined portion on a side surface of the light guide plate LG so as to be held in close contact with the light guide plate LG, and the flexible printed substrate for sending power is connected to the LED light source. Further, a reflective sheet is provided on a side surface or lower surface of the light guide plate LG (surface on a side opposite to a side on which the light-emitting surface is provided), and the light, which reaches the side surface or the lower surface of the light guide plate LG from the LED light source, is guided to the light-emitting surface of the light guide plate LG which surface-emits light toward the liquid crystal substrate LC. The under frame UF may receive the reflective sheet and the LED light source together with the light guide plate LG and the optical sheet OS. In the liquid crystal display device, the light guide plate LG and the like serve as a light source section for supplying a light source which surface-emits light to the liquid crystal substrate LC.

Further, in the liquid crystal display device according to this embodiment, there is provided the inner frame IF for covering components therebelow from an upper side of the under frame UF for receiving the light guide plate LG and the like around sides thereof. The inner frame IF is one mode of a fixing member for fixing the liquid crystal substrate LC, and the inner frame IF fixes the liquid crystal substrate LC while placing the same thereon. In order to transmit the light from the light guide plate LG to the liquid crystal substrate LC, the inner frame IF according to this embodiment is opened in accordance with a position at which a display region DP described below is formed, and is formed into a frame shape. As illustrated in FIG. 1, position fixing portions PW are formed on the inner frame IF into a wall shape. A double-faced tape is stuck to the lower polarizing plate of the liquid crystal substrate LC while the position of the liquid crystal substrate LC is fixed by the position fixing portions PW, and thus the liquid crystal substrate LC is fixed to the inner frame IF. Further, the liquid crystal substrate LC may be fixed through fitting with the position fixing portions PW.

In addition, in the liquid crystal display device according to this embodiment, there is provided the outer frame OF for covering components therebelow from an upper side of the liquid crystal substrate LC around sides of the inner frame IF and the under frame UF. The outer frame OF has an opening formed thereon, and covers the liquid crystal substrate LC in a frame-shaped manner. Further, the liquid crystal substrate LC and the inner frame IF fixing the liquid crystal substrate LC are provided inside the outer frame OF. At the opening of the outer frame OF, the display region DP illustrated in FIG. 3 described below is formed by the liquid crystal substrate LC, and a protecting member PM for protecting the upper polarizing plate and the like of the liquid crystal substrate LC is provided. The display region DP according to this embodiment is a region in which pixel circuits for display are arranged in a matrix in the liquid crystal substrate LC. As illustrated in FIG. 3 described below, the display region DP is provided on the inner side of the region in which the outer frame OF is opened.

Here, in the liquid crystal display device according to this embodiment, screw holes SH are formed in predetermined portions on the side surfaces of the inner frame IF, penetration holes PH are formed in predetermined portions on the side surfaces of the outer frame OF corresponding to the predetermined portions of the inner frame IF, and adjusting screws AS to be inserted into the penetration holes PH and the screw holes SH are provided. Detailed description thereof is made below.

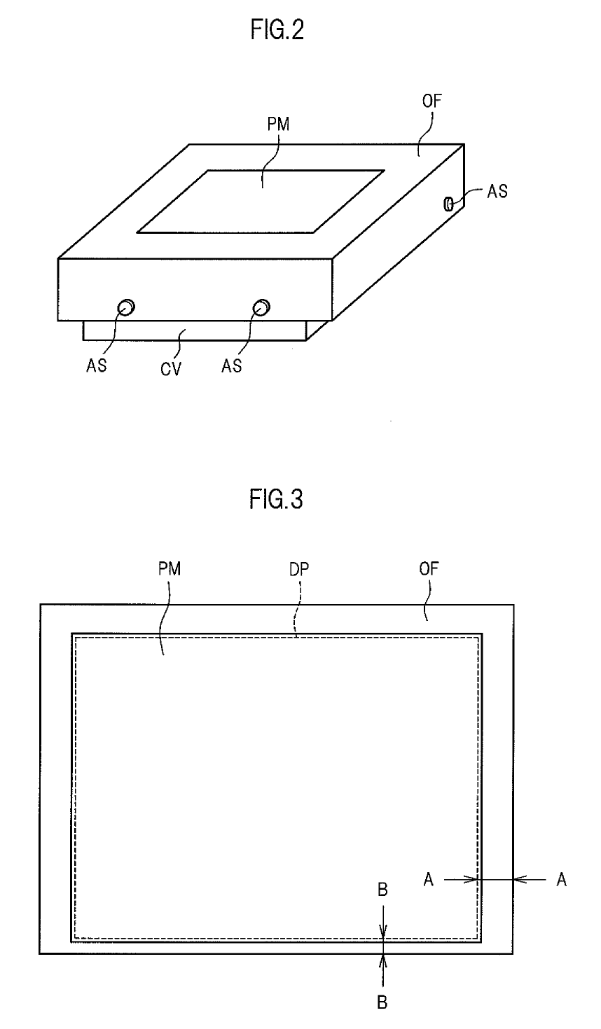

FIG. 2 is a view illustrating a state in which the members illustrated in FIG. 1 are assembled to each other and a cover CV for receiving a connector and the like from below the under frame UF is attached, to thereby complete the liquid crystal display device. Here, the members included in the liquid crystal display device are manufactured so as to satisfy predetermined dimension tolerances and erection tolerances. Specifically, for example, a dimension tolerance of a contour shape of the liquid crystal substrate LC is ±0.2 mm, a dimension tolerance of a contour shape of the inner frame IF is ±0.1 mm, and a dimension tolerance of a contour shape of the outer frame OF is ±0.1 mm. An erection tolerance between the liquid crystal substrate LC and the inner frame IF is ±0.1 mm, and a dimension tolerance of the interval between the outer frame OF and the inner frame IF is ±0.1 mm.

In order to mount the liquid crystal display device illustrated in FIG. 2 to a casing forming a contour of a display to be finally used by a user, it is necessary to regulate the position of the display region DP and the position of the outer frame OF within the predetermined dimension tolerance. Here, FIG. 3 is a view illustrating an example of a tolerance which is regulated in the liquid crystal substrate according to this embodiment. When the members of the present invention have the above-mentioned tolerances, variations of ±0.3 to 0.4 mm occur at portions illustrated in an interval A and an interval B of FIG. 3. In this embodiment, the interval between the predetermined portion of the contour of the outer frame OF and the display region DP is regulated as the dimension tolerance, and hence variations in the interval A and the interval B are decreased within, for example, ±0.1 mm with use of an adjusting mechanism. With use of the adjusting mechanism, a positional relation between the outer frame OF and the display region DP is adjusted after assembly of the liquid crystal display device.

Hereinafter, the adjusting mechanism such as the adjusting screws AS is described in detail.

In the liquid crystal display device according to this embodiment, there is provided the adjusting mechanism for adjusting the position of the inner frame IF with respect to the outer frame OF before the liquid crystal display device is mounted to the casing forming the contour of the display. The adjusting mechanism is provided so as to couple the inner frame IF and the outer frame OF to each other, and at least a part of the adjusting mechanism is exposed in the outer frame OF. The outer frame OF according to this embodiment adjustably retains the positions of the inner frame IF and the liquid crystal substrate LC with respect to the outer frame OF by the adjusting mechanism. Further, after assembly of the liquid crystal display device, the adjusting mechanism can be subjected to adjusting operation by an operator or the like, and the positions of the inner frame IF and the display region DP with respect to the outer frame OF are adjusted in conjunction with the adjusting mechanism.

Specifically, the adjusting mechanism according to this embodiment is the adjusting screws AS. In a state in which the outer frame OF is supported so as to cover the inner frame IF fixing the liquid crystal substrate LC, the adjusting screws AS are inserted into the penetration holes PH and the screw holes SH corresponding thereto.

Here, it is preferred that the inner frame IF be supported by the outer frame OF by providing a temporarily fixing mechanism such as a snap-fit at multiple portions in the outer frame OF and the inner frame IF. In the snap-fit, by fitting a fastening portion of the inner frame IF to a fastening portion provided to the outer frame OF, the inner frame IF is restricted, and thus the inner frame IF is roughly fixed to the outer frame OF. Further, the inner frame IF may be elastically restricted with respect to the outer frame OF with the snap-fit. As described above, the inner frame IF is restricted in its position with respect to the outer frame OF within a movable range determined by the temporarily fixing mechanism such as the snap-fit. As a result, it is easy to insert the adjusting screws AS into the penetration holes PH and the screw holes SH corresponding thereto. Note that, similarly, the under frame UF and the inner frame IF may be fixed to each other with the snap-fit.

Further, the screw holes SH of the inner frame IF are formed correspondingly to the positions in which the penetration holes PH of the outer frame OF are formed. When the adjusting screws AS are inserted into the outer frame OF and the inner frame IF which are temporarily fixed to each other by the temporarily fixing mechanism, the position of the inner frame IF with respect to the outer frame OF is adjustably fixed within a range in which the outer frame OF and the inner frame IF are restricted by the temporarily fixing mechanism.

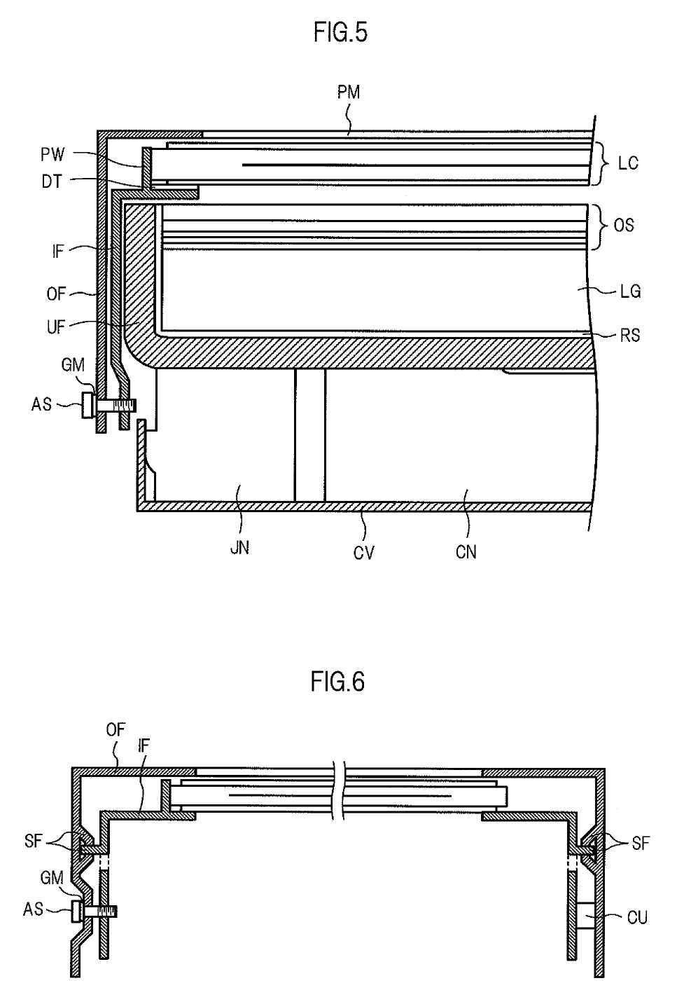

Screw heads of the adjusting screws AS are formed to have a diameter larger than a hole diameter of the penetration holes PH of the outer frame OF, and the screw heads are engaged with the outer frame OF to be exposed to the outside of the outer frame OF. Further, as illustrated in FIG. 5, etc. described below, between the screw heads of the adjusting screws AS and the outer frame OF, rubber washers GM or the like are provided so as to interpose therebetween, and the rubber washers GM are bonded to the outer frame OF at the vicinities of the penetration holes PH.

The adjusting screws AS are rotatably held by the rubber washers GM with respect to the outer frame OF. Specifically, there are provided the rubber washers GM which increase frictional force in a direction in which the adjusting screws AS advance and retreat with respect to the penetration holes PH than frictional force in a rotating direction of the adjusting screws AS. As a result, even when the adjusting screws AS rotate, the positions of the screw heads are fixed with respect to the outer frame OF.

Then, male threads are carved on screw stocks of the adjusting screws AS, respectively, and are screwed into female threads carved in the screw holes SH, and the screw heads of the adjusting screws AS are rotatably fixed to the outer frame OF. As a result, owing to rotation of the adjusting screws AS, it is possible to adjust the positional relation of the inner frame IF with respect to the outer frame OF.

The adjusting screws AS in this embodiment are provided so as to adjust the position of the display region DP, which varies in a range of ±0.3 to 0.4 mm with respect to the opening of the outer frame OF, in every liquid crystal display device. Therefore, when a range in which adjustment is possible by the adjusting screws AS is approximately same as (or slightly smaller than) that of the above-mentioned varying, the tolerances in the interval A and the interval B in FIG. 3 can be decreased to approximately ±0.1 mm.

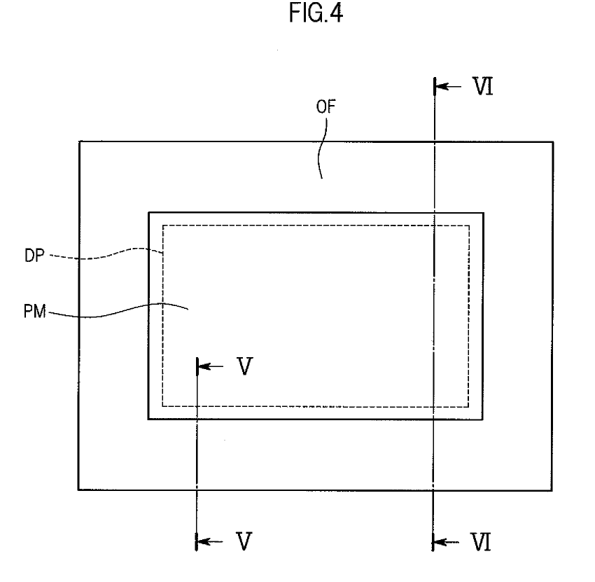

In addition, hereinafter, with reference to FIGS. 4 and 5, states of the outer frame OF, the inner frame IF provided inside the outer frame OF, and the adjusting screws AS provided so as to couple the inner frame IF and the outer frame OF to each other are described in detail.

Here, FIG. 4 is a schematic top view of the liquid crystal display device according to this embodiment, and the adjusting screws AS are omitted in FIG. 4. As illustrated in FIG. 4, the display region DP is formed in the opening of the outer frame OF by the liquid crystal substrate LC. FIG. 5 is a schematic sectional view of the liquid crystal display device according to this embodiment taken along the line V-V of FIG. 4. As illustrated in FIG. 5, a connector CN is provided further under the under frame UF, and the cover CV is attached to the connector CN by a joint portion JN so as to cover the connector CN.

As illustrated in FIG. 5, one of the screw holes SH is formed in the side surface of the inner frame IF, and one of the penetration holes PH is formed in the side surface of the outer frame OF. One of the adjusting screws AS is inserted into those holes. The screw stocks and portions in which the male threads are carved of the adjusting screws AS are formed to have lengths sufficiently larger than a range in which the interval A and the interval B vary. Further, the adjusting screws AS are engaged with the outer frame OF in the penetration holes PH to be rotatably fixed thereto, and are screwed into the screw holes SH of the inner frame IF with a predetermined interval between the outer frame OF and the inner frame IF. Then, the adjusting screws AS pass through the inner frame IF in the screw holes SH so as to protrude parts of the screw stocks to the inner side of the inner frame IF. It is desirable that the length by which the adjusting screws AS protrude from the screw holes SH be sufficiently larger than the above-mentioned range in which the interval A and the interval B vary.

In FIG. 5, when the screw heads of the adjusting screws AS exposed to the outside are rotated, for example, clockwise, the screw holes SH into which the adjusting screws AS are screwed move toward the outer frame OF. As a result, the interval provided between the inner frame IF and the outer frame OF becomes narrow in accordance with a rotation amount, and the liquid crystal substrate LC fixed to the inner frame IF also moves toward the outer frame OF in conjunction with the rotation amount.

The inner frame IF supports the outer peripheral portion of the liquid crystal substrate LC in a frame-shaped manner, and the position fixing portions PW are formed on portions in which the inner frame IF supports the liquid crystal substrate LC. The position fixing portions PW are formed into a wall shape to be upright parallel to a thickness direction of the liquid crystal substrate LC. As illustrated in FIG. 5, the liquid crystal substrate LC is fixed by double-faced tapes DT provided to the position fixing portions PW, and a double-faced tape DT provided to the frame-shaped portion of the inner frame IF.

The position fixing portions PW prevent the position of the liquid crystal substrate LC from changing when the material of the double-faced tape DT deteriorates and thus its adhesive force is decreased. As illustrated in FIG. 1, the position fixing portions PW maybe formed along respective sides of the liquid crystal substrate LC. Further, the position fixing portion PW may be formed along a part of any one of the sides of the liquid crystal substrate LC so as to prevent the position of the liquid crystal substrate LC from shifting in a specific direction by acting, for example, gravity and restoring force due to the flexible printed substrate on the liquid crystal substrate LC when the adhesive force of the double-faced tapes DT is decreased.

Further, as illustrated in FIG. 5, the penetration holes PH, the screw holes SH, and the adjusting screws AS are provided below the under frame UF, which receives the members such as the light guide plate LG forming the light source, so as to be further spaced apart from the display region DP. As illustrated in FIG. 5, the inner frame IF bends inwardly at the portion below the under frame UF, to thereby secure the interval with the outer frame OF. Further, the screw holes SH are formed in such positions as to prevent the adjusting screws AS and the under frame UF from interfering with each other, and hence it is possible to cause the screw stocks of the adjusting screws AS to sufficiently protrude from the screw holes SH.

As illustrated in FIG. 1, the adjusting screws AS are provided at three points in this embodiment. Specifically, as illustrated in FIG. 1, two adjusting screws AS are provided at one side of the outer frame OF, and one adjusting screw AS is provided at another one side perpendicular to the one side thereof. With this configuration, the position of the display region DP can be adjusted in longitudinal and lateral directions, and adjustment is possible even when the display region DP deviates with respect to the opening of the outer frame OF in a θ direction.

Further, the adjusting screws AS may be provided one-by-one to three different sides of the outer frame OF. In this case, the adjusting screws AS, which are provided to two sides opposed to each other, are provided at positions at which they are diagonally opposed to each other such that the deviation in the θ direction can be adjusted and one of the adjusting screws AS is provided at a portion other than that on an extended line of the other of the adjusting screws.

### Second Embodiment

FIG. 6 is a sectional schematic top view of a liquid crystal display device according to a second embodiment of the present invention taken along the line VI-VI of FIG. 4, and schematically illustrates a state of one of the adjusting screws AS interposed between the inner frame IF and the outer frame OF.

As illustrated in FIG. 6, the outer frame OF in the second embodiment is provided with recesses for receiving the screw heads of the adjusting screws AS. The penetration holes PH are formed in the recesses, and the screw heads of the adjusting screws AS are received in the recesses of the outer frame OF, to thereby facilitate attachment of the outer frame OF to the casing.

Note that, snap-fits SF are provided in section taken along the line VI-VI of FIG. 4 in which one of the adjusting screws AS exists, and a cushion CU is provided in a gap between the inner frame IF and the outer frame OF on a side opposite to a side on which one of the adjusting screws AS is provided. The liquid crystal display device according to the second embodiment is otherwise substantially the same as that according to the above-mentioned first embodiment.

### Third Embodiment

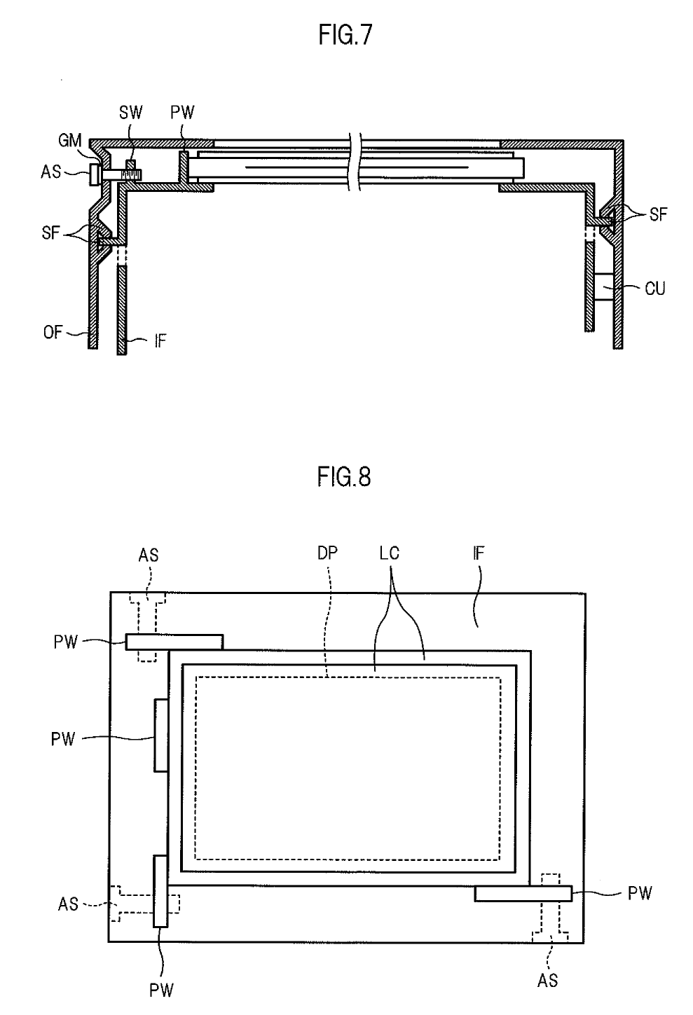

FIG. 7 is a sectional schematic top view of a liquid crystal display device according to a third embodiment of the present invention taken along the line VI-VI of FIG. 4, and schematically illustrates a state of one of the adjusting screws AS interposed between the inner frame IF and the outer frame OF.

As illustrated in FIG. 7, the outer frame OF in the third embodiment is provided with recesses for receiving the screw heads of the adjusting screws AS. In particular, screw-hole-drilled walls SW are formed in a wall-shaped manner at portions of the inner frame IF supporting the outer peripheral portion of the liquid crystal substrate LC, and the screw holes SH are formed in the screw-hole-drilled walls SW. The screw-hole-drilled walls SW are formed at positions spaced apart from the position fixing portions PW such that a sufficient space for the screw stocks of the adjusting screws AS to protrude is secured.

The adjusting screws AS are engaged with the outer frame OF in the penetration holes PH to be rotatably fixed thereto, and are screwed into the screw holes SH formed in the screw-hole-drilled walls SW with predetermined intervals between the outer frame OF and the screw-hole-drilled walls SW. Then, the parts of the screw stocks pass through the screw-hole-drilled walls SW in the screw holes SH, and protrude so as to be prevented from interfering with the liquid crystal substrate LC and the position fixing portions PW.

Note that, the third embodiment is the same as the above-mentioned second embodiment in that the outer frame OF is provided with the recesses for receiving the screw heads of the adjusting screws AS, and that the snap-fit SF and the cushion CU are provided. The liquid crystal display device according to the third embodiment is otherwise substantially the same as that according to the above-mentioned first embodiment.

### Fourth Embodiment

FIG. 8 is a view illustrating a state in which the liquid crystal substrate LC is fixed to the inner frame IF in a liquid crystal display device according to a fourth embodiment of the present invention, and schematically illustrating a state in which the adjusting screws AS are screwed into the position fixing portions PW. In the fourth embodiment, while being brought into contact with a region from a predetermined portion of one of the sides forming the outer periphery of the liquid crystal substrate LC to an end portion (portion of vertex angle) thereof, each of the position fixing portions PW is formed into a wall shape so as to extend beyond the end portion of the liquid crystal substrate LC. Further, each of the screw holes SH is formed in a portion of the position fixing portion PW provided so as to extend beyond the end portion of the liquid crystal substrate LC, and each of the adjusting screw AS is screwed into each of the screw holes SH. With this configuration, the adjusting screws AS do not interfere with the liquid crystal substrate LC and the like, and the position of the inner frame IF is adjustably fixed to the outer frame OF.

The liquid crystal display device according to the fourth embodiment is otherwise the same as that according to the above-mentioned first embodiment.

Note that, in each of the embodiments including the above-mentioned first embodiment, the adjusting screws AS are provided at three points and the display region DP can also be adjusted in the θ direction. However, more than three adjusting screws AS may be provided and the display region DP may be adjusted in the θ direction. Further, by providing the adjusting screw AS at one point, the position of the display region DP may be adjusted only in one direction. Alternatively, for example, by providing two adjusting screws AS at one side of the outer frame OF, the position of the display region DP may be adjusted in a direction perpendicular to the one side or in the θ direction. Further, by providing the adjusting screws AS one-by-one at one side of the outer frame OF and another one side thereof perpendicular to the one side, the position of the display region DP may be adjusted in two directions.

Note that, in each of the embodiments including the above-mentioned first embodiment, the fixing member for fixing the liquid crystal substrate LC is the inner frame IF. However, it is unnecessary that the fixing member is a frame-shaped member, and the liquid crystal substrate LC may be fixed by multiple supporting members. Further, the inner frame IF may be a member which is formed integrally with the under frame OF and receives the light source. In this case, the screw holes SH may be formed in the member which is formed integrally with the inner frame IF and the under frame UF, and the positional relation with the outer frame OF may be adjusted by the adjusting screws AS.

Note that, in each of the embodiments including the above-mentioned first embodiment, the adjusting screws AS are exemplified as the adjusting mechanism. However, the position of the inner frame IF with respect to the outer frame OF may be adjusted by a mechanism other than the adjusting screws AS. For example, a rail is provided along the inner side of the outer frame OF, and the inner frame IF is fitted to this rail so as to slide therein. As a result, the position of the inner frame IF with respect to the outer frame OF may be adjusted.

Note that, in each of the embodiments including the above-mentioned first embodiment, the rubber washers GM are provided between the adjusting screws AS and the outer frame OF, and bonded to the outer frame OF. However, apart from this, without providing the rubber washers GM, the adjusting screws AS may be rotatably fixed to the outer frame OF by an adhesive resin.

Note that, the outer frame OF, the inner frame IF, the under frame UF, and the like in each of the embodiments including the above-mentioned first embodiment may be made of metal or resin. Further, when the fixing member such as the inner frame IF is in an environment in which temperature changes are severer than those in the outer frame OF, the inner frame IF is made of metal generally having a coefficient of thermal expansion lower than that of a resin, and the outer frame OF is formed by injection molding of a resin. Further, the inner frame IF may be integrally molded of metal and a resin. In this case, for example, portions of the inner frame IF, in which the screw holes SH are formed, are made of resin, and another portion thereof is made of metal. With this configuration, the adjusting screws AS are passed through the inner frame IF temporarily fixed to the outer frame OF. As a result, it is possible to efficiently form the screw holes SR.

Note that, a driving system for the liquid crystal display device according to each of the embodiments of the present invention may be of an in-plane switching (IPS) mode, a vertically aligned (VA) mode, a twisted nematic (TN) mode, or another mode. The liquid crystal display device according to the present invention is not limited to the above-mentioned embodiments, and it goes without saying that various modifications are possible without departing from the technical ideas of the present invention.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal substrate provided with a display region which displays an image by driving a liquid crystal material sandwiched between two substrates;
an outer frame covering at least a part of an outside of the liquid crystal substrate;
a fixing member provided inside the outer frame, for fixing the liquid crystal substrate; and
an adjusting mechanism arranged so as to couple the outer frame and the fixing member to each other, for adjusting a position of the display region with respect to the outer frame through adjusting a position of the fixing member with respect to the outer frame.

2. A liquid crystal display device according to claim 1, wherein the adjusting mechanism is subjected to adjusting operation by exposing at least a part thereof to an outside of the outer frame.

3. A liquid crystal display device according to claim 2, wherein:
the adjusting mechanism comprises at least one adjusting screw which is inserted into a penetration hole formed in the outer frame and is screwed into a screw hole formed in the fixing member correspondingly to the penetration hole; and
the at least one adjusting screw adjusts the position of the fixing member with respect to the outer frame through adjusting an interval provided between the outer frame and the fixing member by being subjected to rotation movement while exposing a screw head thereof to the outside of the outer frame.

4. A liquid crystal display device according to claim 3, wherein:
the fixing member comprises an inner frame for supporting an outer peripheral portion of the liquid crystal substrate; and
the at least one adjusting screw adjusts a position of the inner frame with respect to the outer frame through adjusting an interval between the outer frame and the inner frame.

5. A liquid crystal display device according to claim 4, wherein the inner frame has, on a portion supporting the outer peripheral portion of the liquid crystal substrate, at least one position fixing portion which is brought into contact with the liquid crystal substrate and determines a position of the liquid crystal substrate so as to fix the liquid crystal substrate.

6. A liquid crystal display device according to claim 4, wherein:
the inner frame has, on a portion supporting the outer peripheral portion of the liquid crystal substrate, a screw-hole-drilled wall having the screw hole formed therein; and
the at least one adjusting screw adjusts the position of the inner frame with respect to the outer frame through adjusting an interval between the outer frame and the screw-hole-drilled wall by being screwed into the screw hole.

7. A liquid crystal display device according to claim 5, wherein:
the at least one position fixing portion is formed into a wall shape so as to be brought into contact with a region from a predetermined portion of at least one side of the liquid crystal substrate to an end portion of the liquid crystal substrate along the at least one side thereof and extend beyond the end portion of the liquid crystal substrate;
the at least one position fixing portion has the screw hole formed therein in a portion extending beyond the end portion of the liquid crystal substrate; and
the at least one adjusting screw adjusts the position of the inner frame with respect to the outer frame through adjusting an interval between the outer frame and the position fixing portion by being screwed into the screw hole.

8. A liquid crystal display device according to claim 4, further comprising a light source section provided under the liquid crystal substrate, for supplying a light source to the liquid crystal substrate, wherein:
the inner frame supports the outer peripheral portion of the liquid crystal substrate and covers sides of the light source section;
the inner frame has the screw hole formed therein in a portion covering the sides of the light source section; and
the at least one adjusting screw adjusts the position of the inner frame with respect to the outer frame through adjusting the interval between the outer frame and the inner frame by being screwed into the screw hole.

9. A liquid crystal display device according to claim 3, wherein the adjusting mechanism comprises other adjusting screws provided to a portion other than that on an extended line of the at least one adjusting screw, the other adjusting screws comprising:
at least one of the other adjusting screws for adjustment in the same direction as a direction of the interval to be adjusted by the at least one adjusting screw; and
at least another one of the other adjusting screws for adjustment in a direction perpendicular to the direction of the interval.

10. A liquid crystal display device according to claim 1, wherein:
the outer frame and the fixing member are temporarily fixed to each other so as to form together a temporarily fixing portion for restricting a positional relation therebetween; and
the adjusting mechanism adjusts the position of the fixing member with respect to the outer frame within a range in which the outer frame and the fixing member are restricted by the temporarily fixing portion.

11. A liquid crystal display device according to claim 2, wherein the outer frame has, in a portion in which the part of the adjusting mechanism is exposed, a recess formed so as to receive the part of the adjusting mechanism.

12. A liquid crystal display device according to claim 3, wherein the fixing member is integrally molded of a metal and a resin, and at least a portion of the fixing member is made of the resin, the portion thereof having the screw hole which is formed therein and into which the at least one adjusting screw is screwed.
